(19) United States
(12) Patent Application Publication
(10) Pub. No.: US 2025/0158680 A1
(43) Pub. Date: May 15, 2025

(54) TECHNIQUES FOR CHANNEL STATE INFORMATION REFERENCE SIGNAL-BASED USER EQUIPMENT BEAM SELECTION

(71) Applicant: QUALCOMM Incorporated, San Diego, CA (US)

(72) Inventors: Jun ZHU, San Diego, CA (US); Raghu Narayan CHALLA, San Diego, CA (US); Mihir Vijay LAGHATE, San Diego, CA (US); Brian Clarke BANISTER, San Diego, CA (US); Vivek SHIRVANTE, San Diego, CA (US); Dominic BOIKO, Thornton, CO (US); Gerardo Maximiliano GONZALEZ, Stockton, CA (US); Raj Kumar NATTHA, San Diego, CA (US); Priyanka YENIGALLA, Erie, CO (US); Kevin YING, San Diego, CA (US); Sumanth Kumar KOTA, Hyderabad (IN)

(21) Appl. No.: 18/838,370

(22) PCT Filed: Mar. 10, 2023
(86) PCT No.: PCT/US2023/064130

§ 371 Date: Aug. 14, 2024

(30) Foreign Application Priority Data
Apr. 11, 2022 (IN) 202241021407

(51) Int. Cl. H04B 7/06; H04L 5/00; H04W 76/28

(52) U.S. Cl. CPC H04B 7/0626; H04B 7/06952; H04L 5/0005; H04W 76/28

(57) ABSTRACT

Various aspects of the present disclosure generally relate to wireless communication. In some aspects, a user equipment (UE) may identify one or more parameters associated with a communication link. The UE may enable, based at least in part on the identified one or more parameters, channel state information reference signal (CSI-RS)-based UE beam selection. The UE may receive a set of CSI-RSs. The UE may select a UE beam based at least in part on the CSI-RSs. Numerous other aspects are described.

### CROSS-REFERENCE TO RELATED APPLICATION

This Patent application claims priority to Indian Patent Application number 202241021407, filed on Apr. 11, 2022, entitled “TECHNIQUES FOR CHANNEL STATE INFORMATION REFERENCE SIGNAL-BASED USER EQUIPMENT BEAM SELECTION.” The disclosure of the prior Application is considered part of and is incorporated by reference in this Patent Application.

### FIELD OF THE DISCLOSURE

Aspects of the present disclosure generally relate to wireless communication and to techniques and apparatuses for channel state information reference signal-based user equipment beam selection.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include identifying one or more parameters associated with a communication link. The method may include enabling, based at least in part on the identified one or more parameters, channel state information reference signal (CSI-RS)-based UE beam selection. The method may include receiving a set of CSI-RSs. The method may include selecting a UE beam based at least in part on the CSI-RSs.

Some aspects described herein relate to a method of wireless communication performed by a UE. The method may include measuring, via multiple UE beams, a set of CSI-RSs within multiple component carriers. The method may include identifying total spectral efficiencies, across the multiple component carriers, associated with one or more of the multiple UE beams. The method may include selecting a UE beam, of the one or more of the multiple UE beams, based at least in part on the total spectral efficiencies across the multiple component carriers.

Some aspects described herein relate to a UE for wireless communication. The user equipment may include a memory and one or more processors coupled to the memory. The one or more processors may be configured to identify one or more parameters associated with a communication link. The one or more processors may be configured to enable, based at least in part on the identified one or more parameters, CSI-RS-based UE beam selection. The one or more processors may be configured to receive a set of CSI-RSs. The one or more processors may be configured to select a UE beam based at least in part on the CSI-RSs.

Some aspects described herein relate to a UE for wireless communication. The UE may include a memory and one or more processors coupled to the memory. The one or more processors may be configured to measure, via multiple UE beams, a set of CSI-RSs within multiple component carriers. The one or more processors may be configured to identify total spectral efficiencies, across the multiple component carriers, associated with one or more of the multiple UE beams. The one or more processors may be configured to select a UE beam, of the one or more of the multiple UE beams, based at least in part on the total spectral efficiencies across the multiple component carriers.

Some aspects described herein relate to a non-transitory computer-readable medium that stores a set of instructions for wireless communication by a UE. The set of instructions, when executed by one or more processors of the UE, may cause the UE to identify one or more parameters associated with a communication link. The set of instructions, when executed by one or more processors of the UE, may cause the UE to enable, based at least in part on the identified one or more parameters, CSI-RS-based UE beam selection. The set of instructions, when executed by one or more processors of the UE, may cause the UE to receive a set of CSI-RSs. The set of instructions, when executed by one or more processors of the UE, may cause the UE to select a UE beam based at least in part on the CSI-RSs.

Some aspects described herein relate to a non-transitory computer-readable medium that stores a set of instructions for wireless communication by a one or more instructions that, when executed by one or more processors of a UE. The set of instructions, when executed by one or more processors of the one or more instructions that, when executed by one or more processors of a UE, may cause the one or more instructions that, when executed by one or more processors of a UE to measure, via multiple UE beams, a set of CSI-RSs within multiple component carriers. The set of instructions, when executed by one or more processors of the one or more instructions that, when executed by one or more processors of a UE, may cause the one or more instructions that, when executed by one or more processors of a UE to identify total spectral efficiencies, across the multiple component carriers, associated with one or more of the multiple UE beams. The set of instructions, when executed by one or more processors of the one or more instructions that, when executed by one or more processors of a UE, may cause the one or more instructions that, when executed by one or more processors of a UE to select a UE beam, of the one or more of the multiple UE beams, based at least in part on the total spectral efficiencies across the multiple component carriers.

Some aspects described herein relate to an apparatus for wireless communication. The apparatus may include means for identifying one or more parameters associated with a communication link. The apparatus may include means for enabling, based at least in part on the identified one or more parameters, CSI-RS-based beam selection. The apparatus may include means for receiving a set of CSI-RSs. The apparatus may include means for selecting a beam based at least in part on the CSI-RSs.

Some aspects described herein relate to an apparatus for wireless communication. The apparatus may include means for measuring, via multiple beams, a set of CSI-RSs within multiple component carriers. The apparatus may include means for identifying total spectral efficiencies, across the multiple component carriers, associated with one or more of the multiple beams. The apparatus may include means for selecting a beam, of the one or more of the multiple beams, based at least in part on the total spectral efficiencies across the multiple component carriers.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating examples of channel state information reference signals (CSI-RSs) beam management procedures, in accordance with the present disclosure.

FIGS. 4-6 are diagrams illustrating examples of beam selection using CSI-RS acquisition resources, in accordance with the present disclosure.

FIG. 7 is a diagram illustrating an example associated with CSI-RS-based UE beam selection, in accordance with the present disclosure.

FIGS. 8 and 9 are diagrams illustrating example processes associated with CSI-RS-based UE beam selection, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

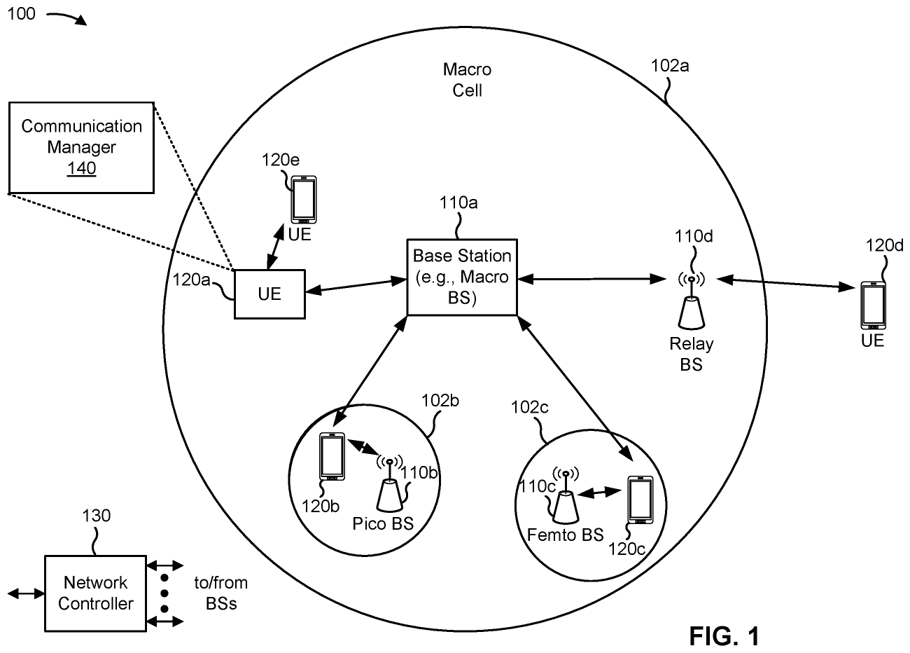

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may identify one or more parameters associated with a communication link; enable, based at least in part on the identified one or more parameters, channel state information reference signal (CSI-RS)-based UE beam selection; receive a set of CSI-RSs; and select a UE beam based at least in part on the CSI-RSs. Additionally, or alternatively, the communication manager 140 may perform one or more other operations described herein. For example, the communication manager 140 may measure, via multiple UE beams, a set of CSI-RSs within multiple component carriers; identify total spectral efficiencies, across the multiple component carriers, associated with one or more of the multiple UE beams; and select a UE beam, of the one or more of the multiple UE beams, based at least in part on the total spectral efficiencies across the multiple component carriers. Additionally, or alternatively, the communication manager 140 may perform one or more other operations described herein.

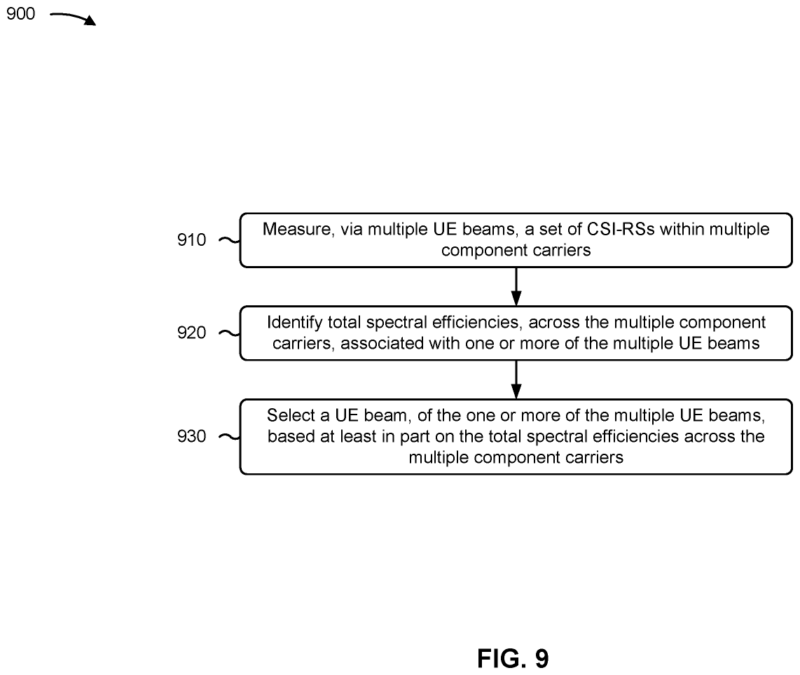

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

As indicated above, FIG. 1 is provided as an example. Other examples may differ from what is described with regard to FIG. 1.

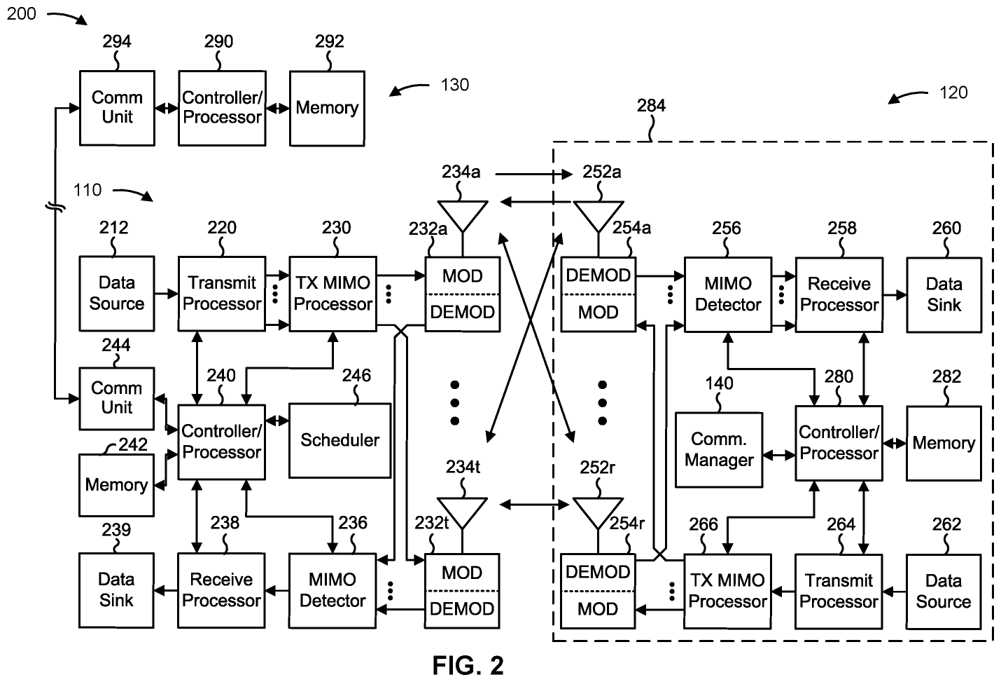

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

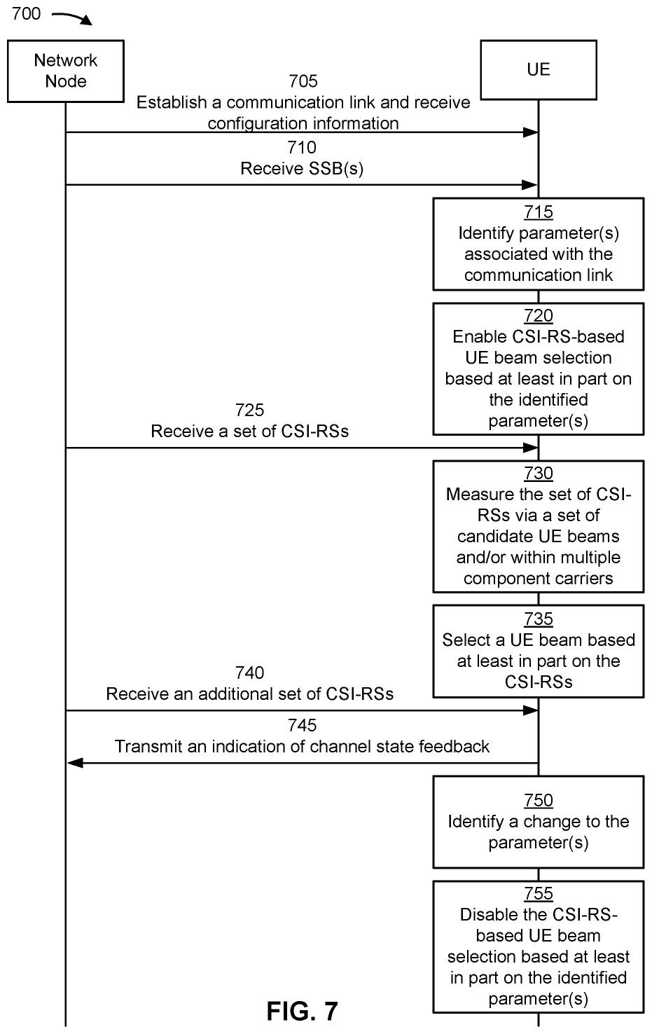

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-10).

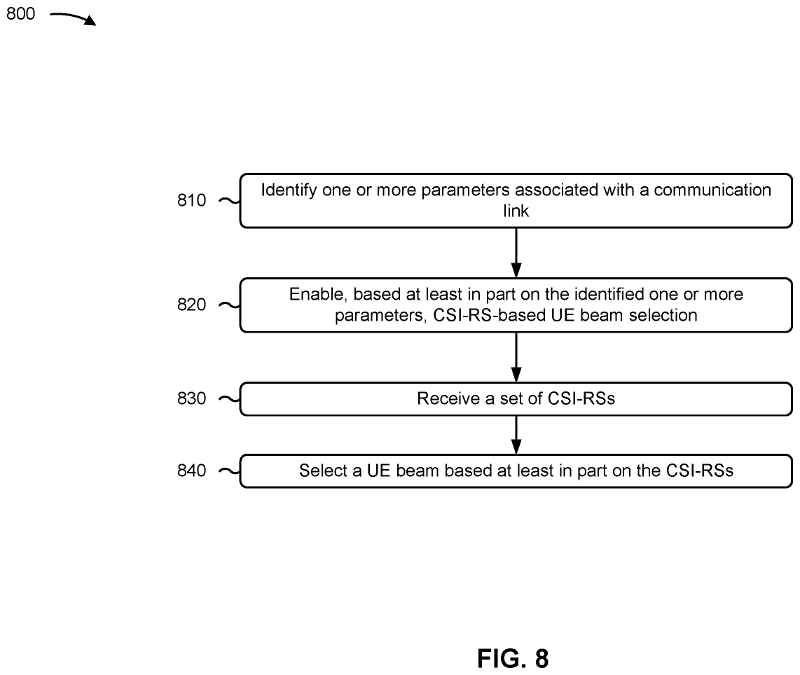

The controller/processor 240 of the base station 110, the controller/processor 280 of the UE 120, and/or any other component(s) of FIG. 2 may perform one or more techniques associated with CSI-RS-based UE beam selection, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for identifying one or more parameters associated with a communication link; means for enabling, based at least in part on the identified one or more parameters, CSI-RS-based UE beam selection; means for receiving a set of CSI-RSs; and/or means for selecting a UE beam based at least in part on the CSI-RSs. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for measuring, via multiple UE beams, a set of CSI-RSs within multiple component carriers; means for identifying total spectral efficiencies, across the multiple component carriers, associated with one or more of the multiple UE beams; and/or means for selecting a UE beam, of the one or more of the multiple UE beams, based at least in part on the total spectral efficiencies across the multiple component carriers. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

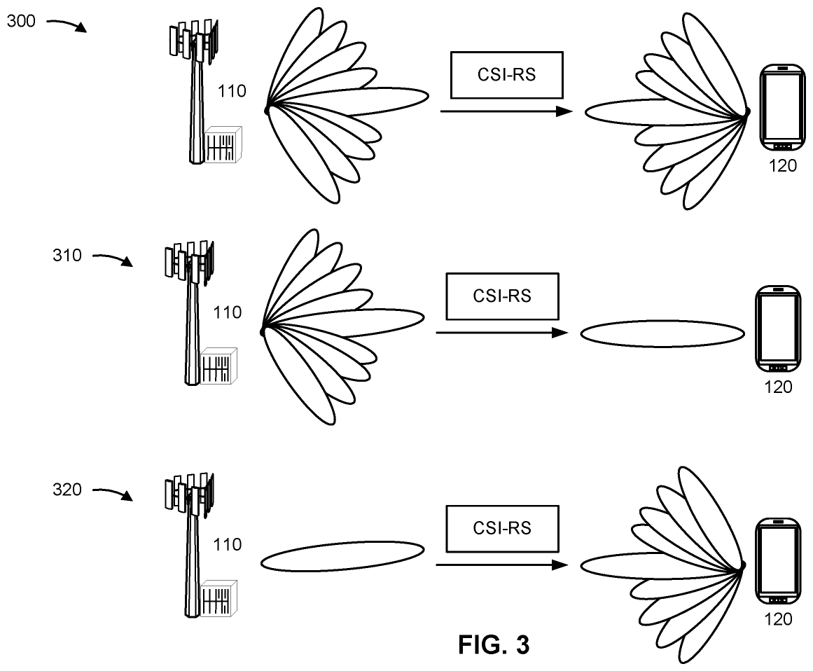

FIG. 3 is a diagram illustrating examples 300, 310, and 320 of CSI-RS beam management procedures, in accordance with the present disclosure. As shown in FIG. 3, examples 300, 310, and 320 include a UE 120 in communication with a base station 110 in a wireless network (e.g., wireless network 100). However, the devices shown in FIG. 3 are provided as examples, and the wireless network may support communication and beam management between other devices (e.g., between a UE 120 and a base station 110 or TRP, between a mobile termination node and a control node, between an IAB child node and an IAB parent node, and/or between a scheduled node and a scheduling node). In some aspects, the UE 120 and the base station 110 may be in a connected state (e.g., a radio resource control (RRC) connected state).

As shown in FIG. 3, example 300 may include a base station 110 and a UE 120 communicating to perform beam management using CSI-RSs. Example 300 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300, CSI-RSs may be configured to be transmitted from the base station 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 300 has been described in connection with CSI-RSs, the first beam management process may also use synchronization signal blocks (SSBs) for beam management in a similar manner as described above.

As shown in FIG. 3, example 310 may include a base station 110 and a UE 120 communicating to perform beam management using CSI-RSs. Example 310 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 3 and example 310, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

As indicated above, FIG. 3 is provided as an example of beam management procedures. Other examples of beam management procedures may differ from what is described with respect to FIG. 3. For example, the UE 120 and the base station 110 may perform the third beam management procedure before performing the second beam management procedure, and/or the UE 120 and the base station 110 may perform a similar beam management procedure to select a UE transmit beam.

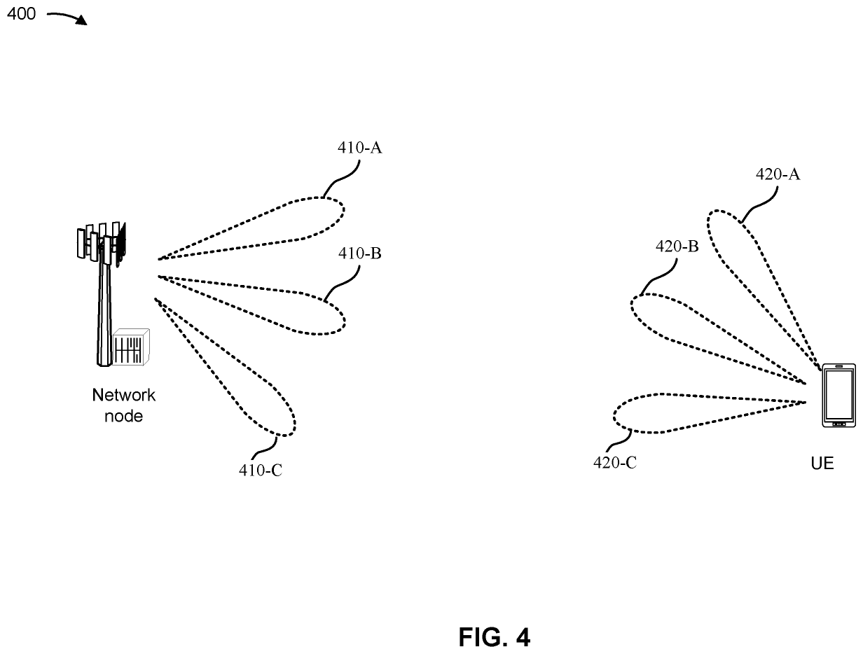

FIG. 4 illustrates an example 400 of beam selection using CSI-RS acquisition resources, in accordance with the present disclosure. As shown in FIG. 4, a network (e.g., wireless network 100) may include a UE and a network node. In some examples, the network node may include, or be included in, an access network entity that is configured to establish a wireless link between one or more additional network nodes and UEs.

The network may support beamformed communications. For example, the network node may communicate with the UE using one or more network node beams 410, and the UE may communicate with the network node using one or more UE beams 420. The network node beams 410 may include a network node beam 410-A, a network node beam 410-B, and/or a network node beam 410-C.

The UE may measure SSBs using multiple UE beams 420 and select a beam as a serving UE beam based at least in part on the measurements. For example, the UE may measure SSBs using a UE beam 420-A, a UE beam 420-B, and/or a UE beam 420-C. The UE may select a beam (e.g., the UE beam 420-B) as a serving UE beam based at least in part on the UE beam having a highest signal strength measurement (e.g., a highest RSRP) on the corresponding SSB. The serving UE beam may be used to receive or transmit a communication via a physical channel, such as a physical downlink control channel (PDCCH), a physical downlink shared channel (PDSCH), a physical uplink control channel (PUCCH), a physical uplink shared channel (PUSCH), and/or a random access channel (RACH) (e.g., RACH message 3), among other examples. For example, the serving UE beam may be selected for control signaling and/or data signaling in uplink and/or downlink communications.

The UE may be configured to measure CSI-RSs for acquisition using candidate UE beams. In some examples, the UE may receive control signaling from the network node, with the control signaling indicating a configuration of the UE to measure the CSI-RSs for acquisition using the candidate UE beams. For example, the UE may identify a set of candidate UE beams to measure on a CSI-RS resource used for acquisition. The list of candidate UE beams may be based at least in part on, or identified from, a set of beams used for serving SSB measurements. For example, a set of K beams may be selected for inclusion in the set of candidate beams based at least in part on measuring SSBs using the set of candidate beams. In some cases, the K beams may be determined based at least in part on highest RSRP measurements, channel impulse response measurements, and/or expected spectral efficiency. Additionally, or alternatively, the K beams may be identified based at least in part on previous CSI-RS measurements. For example, the UE may update or select the set of candidate UE beams based at least in part on previous CSI-RS measurements using previous serving UE beams or previous candidate UE beams.

In some examples, the UE may identify the candidate beams based at least in part on an uplink link budget for the UE. For example, the UE may estimate the uplink link budget based at least in part on a maximum permissible exposure (MPE) limit. The MPE limit may restrict some mmW transmissions or restrict the power of mmW transmissions in the wireless communications system 200. In some cases, the UE may determine a virtual power headroom (VPHR) based at least in part on the MPE limit and select beams which may be closest to the VPHR to measure the strongest beams within the MPE limit. In some cases, the VPHR may be different from an actual power headroom for the UE.

The UE may identify a slot and symbol where resources for the CSI-RS for acquisition will be scheduled. In some wireless communications systems, a UE may identify the slot and symbol based at least in part on PDCCH in a same slot as the resources for the CSI-RS. However, the UE in these systems may not have sufficient time to both process the PDCCH indicating the CSI-RS and switch to a candidate UE beam (e.g., from the serving UE beam).

The UE may implement techniques to predict the slot and symbol of the resources for the CSI-RS to support measuring CSI-RS for acquisition using candidate UE beams. For example, the UE may estimate a slot or symbol, or both, for the CSI-RS based at least in part on past scheduled aperiodic resources or CSI-RS configurations, or both. The UE may schedule either a candidate UE beam (e.g., the UE beam 420-A or the UE beam 420-C) or the serving UE beam (e.g., the UE beam 420-B) for at least the identified symbol during the identified slot. This may enable the UE to measure the CSI-RS using the candidate UE beam without waiting to process the PDCCH, as the resources carrying the CSI-RS may have already occurred once the PDCCH is processed.

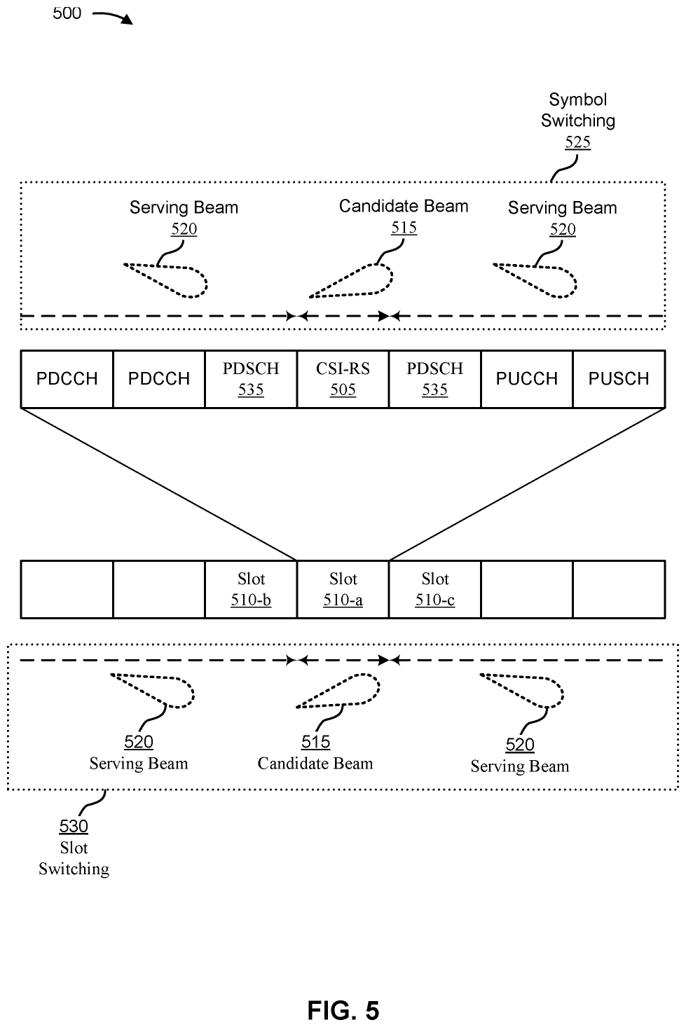

In some cases, the UE may schedule a UE beam 420 for the entire slot when scheduling the UE beam 420 for the CSI-RS symbol. In some examples, there may be PDCCH and PDSCH in the same slot. The PDSCH may be frequency division multiplexed on the same symbol as CSI-RS. Using the same beam throughout the slot may provide better channel estimation using the PDSCH DMRS which may be on another symbol of the same slot. If the CSI-RS slot prediction is inaccurate (e.g., due to scheduling variations at network node), then the UE may use the same beam for multiple slots in a time window around the predicted slot. Some techniques for predicting symbols, slots, or both, are described in more detail with reference to FIG. 5.

The UE may measure spectral efficiency on the resource carrying the CSI-RS used for acquisition. In some cases, spectral efficiency may be measured for each rank separately. The UE may perform filtering, biasing, or thresholding for a first rank and a second rank of the CSI-RS measurement.

The UE may prepare a report to transmit to the network node including a last measurement on the serving UE beam (e.g., the UE beam 420-B) or a recent measurement of a candidate UE beam (e.g., the UE beam 420-A or the UE beam 420-C). In some cases, the UE may generate the report based at least in part on, or including information associated with, both a recent measurement for the serving UE beam and measurements for one or more candidate UE beams. The UE may then transmit the report to the network node. The UE and/or the network node may process a measured and/or estimated spectral efficiency for serving beam selection. In some cases, the UE may use the spectral efficiency to update or reselect a serving UE beam. In some examples, the network node may update a network node beam 410 or update a configuration for a beam pair link based at least in part on the spectral efficiency.

In some examples, the UE may sweep UE beams 420 to measure CSI-RS with different UE candidate beams over one or more occasions. For example, the UE may measure a first CSI-RS using UE beam 420-A (e.g., a first candidate UE beam), measure a second CSI-RS using UE beam 420-B (e.g., the serving UE beam), and measure a third CSI-RS using UE beam 420-C (e.g., a second candidate UE beam), among other examples. These techniques may provide enhanced beam selection, which may lead to selecting stronger beams and greater throughput.

In some examples described herein, the CSI-RSs may include CSI-RSs that are configured to be usable for cell acquisition. For example, the CSI-RSs may not include tracking or repetition fields. The CSI-RSs may be used for channel state feedback to optimize downlink throughput by link adaptation. In some cases, the CSI-RS resources may be configured or selected based at least in part on the CSI-RSs being used for acquisition.

Some slots may include DMRS resources, which may be used to aperiodically transmit downlink data grants. Downlink grants may be aperiodically based at least in part on scheduled data being aperiodic. The network node may indicate a presence of PDSCH and/or DMRS symbols through DCI on a PDCCH symbol K0 slots before the PDSCH. Some systems may use K0=0, where the PDCCH resources and the PDSCH resources are in a same slot. Information for the PDSCH and DMRS may be indicated by the scheduling DCI. In some cases, if a PDSCH grant is rank-2, then the DMRS may also be rank-2.

In some examples, similar techniques may be used to sweep UE beams 420 on PDSCH slots and measure spectral efficiency and/or signal-to-noise ratio (SNR) on DMRSs transmitted during the PDSCH slots. For example, the UE may identify a set of candidate beams and select a serving UE beam based at least in part on sweeping the UE beams 420 on the PDSCH slots. The UE may count a number of downlink grants with DMRSs and switch from the serving UE beam to a candidate UE beam after reaching a threshold number of downlink grants with DMRSs. In some cases, the UE may switch to the candidate UE beam for all channels of one or more slots. The UE may perform SNR and/or spectral efficiency measurements and/or estimations based at least in part on the DMRSs received using the candidate UE beam. The UE may transmit a measurement report to the network node, with the report indicating a measurement based at least in part on a last DMRS (e.g., a last SNR or spectral efficiency measurement) received using the UE serving beam and/or one or more measurements based at least in part on a DMRS received using the candidate UE beam, among other examples. In some cases, some techniques or aspects for using a candidate UE beam to measure CSI-RS may be implemented to measure DMRS using a candidate UE beam.

As indicated above, FIG. 4 is provided as an example. Other examples may differ from what is described with regard to FIG. 4.

FIG. 5 illustrates an example 500 of beam selection using CSI-RS acquisition resources, in accordance with the present disclosure.

A UE may measure CSI-RSs 505 in a slot 510 using a candidate UE beam 515. The CSI-RSs 505 may be an example of a CSI-RS used for acquisition, and the UE may measure the CSI-RSs 505 using a candidate UE beam 515 for enhanced beam selection techniques.

To measure the CSI-RSs 505, the UE may identify a slot 510 and symbol where resources for the CSI-RSs 505 will be scheduled. In some wireless communications systems, the CSI-RS resources may be indicated or scheduled according to downlink control information included in PDCCH in a same slot 510 as the scheduled resources for the CSI-RSs. For example, the PDCCH resources in the first or second symbol of slot 510-A may indicate resources for the CSI-RSs 505.

Devices described herein may implement techniques to support switching to a candidate UE beam 515 (e.g., from a serving UE beam 520) to measure the CSI-RSs 505 by predicting the scheduling for the CSI-RSs 505. By implementing these techniques, the UE may perform the switch before the PDCCH has finished processing and with sufficient time to finish the switching and measure the CSI-RSs 505. For example, the UE may estimate or predict a slot 510 or symbol, or both, for the CSI-RSs 505 based at least in part on past scheduled aperiodic resources or CSI-RS configurations, or both. This may enable the UE to measure the CSI-RSs 505 using the candidate UE beam 515 without waiting to process the PDCCH, as the resources carrying the CSI-RSs 505 may have already occurred once the PDCCH is processed.

The UE may implement a symbol-based switching 525 or a slot-based switching 530, or both. The UE may schedule the candidate UE beam 515 for at least the identified symbol during the identified slot 510. For the symbol-based switching 525, the UE may switch from the serving UE beam 520 to the candidate UE beam 515 for the CSI-RSs 505 but use the serving UE beam 520 for other symbols in the slot 510. For example, the UE may use the serving UE beam 520 for PDCCH, PDSCH 535, and PUSCH in the slot 510-A, and the UE may use the candidate UE beam 515 for the CSI-RSs 505.

For the slot-based switching 530, the UE may schedule at least a whole slot including the CSI-RSs 505 to use the candidate UE beam 515. In a first example, the UE may schedule all of the slot 510-A to use the candidate UE beam 515. In the first example, neighboring slots (e.g., a slot 510-B and a slot 510-C) may use the serving UE beam 520. There may be PDCCH and PDSCH 535 included in a slot 510 with the CSI-RSs 505. In some cases, the PDSCH 535 may be frequency division multiplexed on the same symbol as the CSI-RS. Using the same beam throughout the slot may provide enhanced channel estimation using the PDSCH DMRS, which may be on another symbol of the same slot. In some cases, the slot-based switching 530 may be enabled if a symbol prediction is inaccurate. For example, if the UE predicts a wrong symbol at a first prediction occasion using the symbol-based switching 525, the UE may implement the slot-based switching 530 for a next occasion.

In some cases, if the CSI-RS slot prediction using the slot-based switching 530 is inaccurate, the UE may use the same beam for multiple slots in a time window around the predicted slot. For example, the UE may predict that the CSI-RSs 505 is to be transmitted in the slot 510-A. The UE may switch to use the candidate UE beam 515 for a window of slots around the predicted slot. For example, the UE may use switch to the candidate UE beam 515 for the slot 510-B, the slot 510-A, and the slot 510-C. In other examples, the window may have a different size, cover a different number of slots, or cover portions of slots. In some cases, the UE may use the same beam for each channel in the window. For example, the UE may use the candidate UE beam 515 for PDCCH, PDSCH, PUCCH, PUSCH, sounding reference signal (SRS) transmissions, CSI-RS reception, or any combination thereof.

As indicated above, FIG. 5 is provided as an example. Other examples may differ from what is described with regard to FIG. 5.

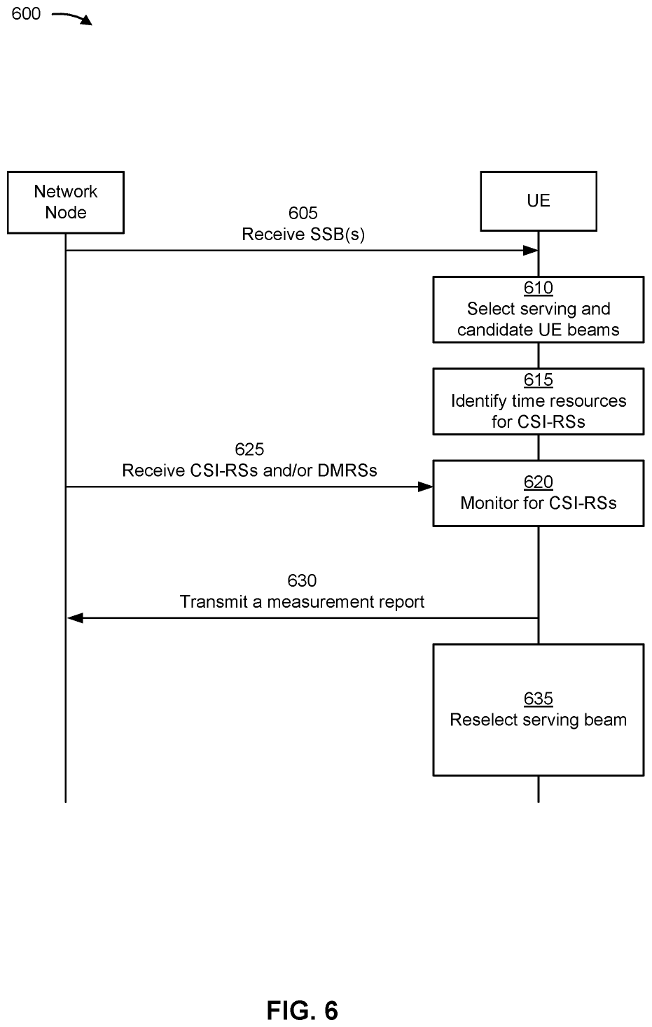

FIG. 6 illustrates an example 600 of beam selection using CSI-RS acquisition resources, in accordance with the present disclosure. In some examples, the network node may include, or may be included in, an access network entity.

As shown by reference number 605, the UE may receive, and the network node may transmit, one or more SSBs. The UE may measure the one or more SSBs to synchronize with the network node and/or to select serving beams. In some aspects, the UE may measure the one or more SSBs using one or more available UE beams to perform a coarse estimation of UE beams that may be suited to communication with the network node associated with the one or more SSBs.

As shown by reference number 610, the UE may select a serving UE beam and one or more candidate UE beams based at least in part on measuring the one or more SSBs. For example, the UE may select a serving UE beam and a set of candidate UE beams for measuring a CSI-RS based at least in part on the set of SSB measurements. In some examples, the UE may select a UE beam associated with an SSB that has a highest RSRP measurement of a set of SSB measurements for the serving UE beam. The UE may select the set of candidate UE beams based at least in part on RSRP measurements of available UE beams used for the set of SSB measurements. For example, the UE may select K UE beams as the set of candidate UE beams based at least in part on an RSRP measurement, channel impulse response measurement, and/or an uplink link budget based at least in part on a VPHR, among other examples.

As shown by reference number 615, the UE may identify a set of time resources for the CSI-RS based at least in part on one or more previous CSI-RS configurations. In some cases, the UE may predict the set of time resources based at least in part on the one or more previous CSI-RS configuration. For example, the UE may predict when the CSI-RS will be transmitted (e.g., in which slot and/or in which symbol of the slot, among other examples) in order to provide sufficient time to switch from a serving UE beam to a candidate UE beam. The CSI-RS may be transmitted in a slot with PDCCH that indicates the scheduling information for the CSI-RS. However, if the UE waits to identify the scheduling information based at least in part on the PDCCH, the resources for the CSI-RS may have already passed once the PDCCH is processed. Therefore, the UE may predict when the CSI-RS is to be transmitted in order to use the UE candidate beam to measure the CSI-RS.

As shown by reference number 620, the UE may monitor for CSI-RSs. For example, the UE may monitor downlink channels during at least the identified set of time resources.

As shown by reference number 625, the UE may receive, and the network node may transmit, the CSI-RSs and/or DMRSs. The UE may measure the CSI-RS using one or more candidate UE beams of the set of candidate UE beams.

In some cases, the UE may monitor a slot that includes the identified set of time resources using the one or more candidate UE beams. For example, the UE may communicate using the one or more candidate UE beams for the whole slot to provide a higher likelihood of measuring the CSI-RSs with the one or more candidate UE beams. In some examples, the UE may use the one or more candidate UE beams for a set of multiple slots based at least in part on a time window associated with the set of time resources, where the UE measures the CSI-RSs during at least a symbol in the slots of the set of multiple slots. For example, the UE may use the one or more candidate UE beams for multiple slots based at least in part on the UE detecting scheduling variations at the network node.

In some cases, the UE may use a candidate UE beam for slightly longer periods across instances if the UE predicts the time resources incorrectly. For example, the UE may first perform symbol-based switching and attempt to switch from a serving UE beam to the candidate UE beam just for a predicted symbol carrying the CSI-RSs. If the UE predicted the symbol wrong, the UE may perform slot-based switching and use the candidate UE beam for a full slot at a subsequent (e.g., next) instance. If the predicted slot for the slot-based switching is wrong, the UE may use the candidate UE beam for a set of multiple slots according to a window around a predicted slot.

In some examples, the set of UE candidate beams may be selected or updated based at least in part on previous CSI-RS measurements. For example, the UE may update the set of candidate UE beams based at least in part on measuring the CSI-RS, additional SSB measurements, one or more CSI-RS measurements using one or more additional candidate UE beams, or any combination thereof.

In some examples, the network node and the UE may implement techniques to measure PDSCH DMRSs using the one or more candidate UE beams and/or perform UE beam sweeping for PDSCH DMRSs. In some cases, the techniques for UE beam sweeping for PDSCH DMRS may be similar to techniques used for beam selection using CSI-RS acquisition resources. For example, the UE may perform a set of SSB measurements and select a serving UE beam and a set of candidate UE beams based at least in part on the SSB measurements. The UE may communicate with the network node and receive a threshold number of downlink grants with DMRSs using the serving UE beam.

Once the UE receives the threshold number of downlink grants with DMRSs, the UE may switch to a candidate UE beam from the set of candidate UE beams. For example, the UE may monitor one or more wireless channels of a slot using a candidate UE beam from the set of candidate UE beams based at least in part on receiving the threshold number of downlink grants. The UE may use the selected candidate UE beam for all channels of one or more slots to monitor for PDSCH DMRSs. In some examples, the network node may transmit DMRSs on PDSCH resources of the slot. The UE may measure, using one or more candidate beams, one or more DMRSs transmitted over one or more wireless channels during the slot.

As shown by reference number 630, the UE may transmit a measurement report. The measurement report may indicate measurements of the CSI-RSs and/or the DMRSs as measured using the one or more candidate beams and/or a last measurement using the serving UE beam, among other examples. For example, the measurement report may indicate an SNR and/or spectral efficiency measurement made using a candidate UE beam and/or or a previous SNR or spectral efficiency measurement made using the serving UE beam, among other examples.

As shown by reference number 635, the UE may reselect a serving beam based at least in part on the CSI-RSs and/or the DMRSs. For example, the UE may process a measurement of the CSI-RSs for serving beam selection purposes. The UE may process the measured and/or estimated spectral efficiency for serving beam selection purposes. For example, the UE may perform filtering, biasing, or thresholding for a first rank and second rank of the measurement as part of reselecting the serving beam. In some cases, the UE may select a serving beam (e.g., reselect the serving beam to a candidate UE beam from the set of candidate UE beams) based at least in part on the measured, filtered, biased, and/or thresholded spectral efficiencies of the set of candidate beams.

As indicated above, FIG. 6 is provided as an example. Other examples may differ from what is described with regard to FIG. 6.

As described herein, CSI-RS-based UE beam selection may improve a reselection process for a UE, which may improve spectral efficiency of downlink communications. For example, using CSI-RS-based UE beam selection may support beam reselection at a time that may not otherwise be available to the UE, which may allow the UE to reselect to a beam having improved SNR, signal-to-interference-plus-noise ratio (SINR), and/or RSRP for downlink communications. In this way, the UE may conserve computing, power, network, and/or communication resources that may have otherwise been used to communicate with an increased error rate and/or to communication with reduced spectral efficiency (e.g., with a reduced MCS). Additionally, or alternatively, using CSI-RS-based UE beam selection may provide additional benefits when used under other conditions. For example, the UE may use CSI-RS-based UE beam selection to select beams for a rank 2 or higher communication, whereas an SSB-based UE beam selection may only be usable for a rank 1 communication (e.g., based at least in part on the SSB being a rank 1 signal).

However, in some conditions, using CSI-RS-based UE beam selection may degrade performance of downlink communications based at least in part on the UE using CSI-RSs for beam selection instead of another purpose (e.g., providing channel state feedback (CSF), among other examples).

For example, CSI-RS-based UE beam selection may degrade performance of downlink communications under high mobility. CSI-RS-based UE beam selection may degrade performance under high mobility based at least in part on CSI-RS-based UE beam selection using CSI-RSs as acquisition reference signals, which increases a periodicity of transmitting CSF. During high Doppler (e.g., with a Doppler value satisfying a threshold) and/or high rotation (e.g., with rotation speeds that satisfy a threshold), downlink communications may be degraded based at least in part on increased periodicity such that gains from using CSI-RS-based UE beam selection may be negated and/or overcome by effects of the increased periodicity of transmitting the CSF.

In some examples CSI-RS-based UE beam selection may fail to improve performance of downlink communications under low signal strength (e.g., SNR and/or RSRP that fail to satisfy a threshold) communications. For example, CSI-RS-based UE beam selection may be used for rank 2 UE beam selection. However, when communicating with low signal strength, SSB-based UE beam selection may be sufficient to optimize rank 1 downlink communication performance. Additionally, or alternatively, CSI-RS-based UE beam selection includes applying a sub-optimal beam (e.g., a candidate UE beam) on the CSI-RS slot, which may increase a likelihood of PDCCH failure.

In some examples CSI-RS-based UE beam selection may fail to improve performance of communications when power head room (e.g., VPHR) for uplink is low (e.g., VPHR that fails to satisfy a threshold). Similar to communications under low signal strength, when power head room is low, the UE has a relatively high likelihood of communicating using rank 1 communications. Additionally, or alternatively, uplink communications may be degraded based at least in part on the UE selecting a candidate beam that is a sub-optimal beam in terms of RSRP and/or pathloss. In some examples, the UE may cause PUCCH failure based at least in part on reduced RSRP and/or pathloss caused by performing CSI-RS-based UE beam selection.

In some examples CSI-RS-based UE beam selection may fail to improve performance of downlink communications when communicating using discontinuous reception (DRX). For example, CSI-RS-based UE beam selection may degrade performance when a DRX-on cycle is not extended to allow additional resources to perform CSI-RS-based UE beam selection and CSF. This may be based at least in part on the UE using CSI-RSs as CSI acquisition reference signals rather than for measuring and reporting CSF, when in DRX, the UE is configured to wake up for CSF measurements with reduced frequency than other communication modes (e.g., DRX connected mode, among other examples). Additionally, or alternatively, performing CSI-RS-based UE beam selection may not provide a benefit for rank 2 optimization if no PDSCH is scheduled during the DRX occasion.

In some aspects described herein, CSI-RS-based UE beam selection (e.g., beam dithering) may be enabled or disabled based at least in part on one or more parameters of a communication link. For example, the UE may enable or disable the CSI-RS-based UE beam selection transparently (e.g., without indicated enablement or disablement to a network node) based at least in part on the one or more parameters being associated with improved or degraded communications with the network node.

In some aspects, the UE may be configured to enable CSI-RS-based UE beam selection based at least in part on an SSB RSRP measured on a serving UE beam satisfying (e.g., being greater than) a first SSB threshold. In this way, the UE may be configured to ensure PDCCH quality and focus on a gain of using CSI-RS-based UE beam selection when communicating using at least rank-2.

In some aspects, the UE may be configured to enable CSI-RS-based UE beam selection based at least in part on a VPHR associated with the serving UE beam satisfying (e.g., being greater than) a first VPHR threshold. In this way, the UE may be configured to ensure PUCCH quality and to avoid loss for uplink communications.

In some aspects, the UE may be configured to enable CSI-RS-based UE beam selection based at least in part on a rotation speed of the UE satisfying a first rotation speed threshold. For example, an inertial measurement unit (IMU) may measure the rotation speed of the UE, and the UE may determine whether the rotation speed satisfies the first rotation speed threshold.

In some aspects, the UE may be configured to enable CSI-RS-based UE beam selection based at least in part on a movement speed satisfying a first movement speed threshold. For example, the UE may measure the movement speed based at least in part on a Doppler measurement.

In some aspects, the UE may be configured to enable CSI-RS-based UE beam selection based at least in part on a DRX-on duration satisfying a first cycle duration threshold. In some aspects, the UE may be configured to enable CSI-RS-based UE beam selection based at least in part on a DRX-on timer satisfying a first on-duration timer threshold (e.g., indicating that the DRX-on cycle is extended for traffic).

In some aspects, the UE may be configured to disable CSI-RS-based UE beam selection based at least in part on an SSB RSRP measured on a serving UE beam satisfying (e.g., being greater than) a first SSB threshold. In this way, the UE may be configured to ensure PDCCH quality and focus on a gain of using CSI-RS-based UE beam selection when communicating using at least rank-2.

In some aspects, the UE may be configured to disable CSI-RS-based UE beam selection based at least in part on a VPHR associated with the serving UE beam failing to satisfy (e.g., being less than) a second VPHR threshold. In this way, the UE may be configured to ensure PUCCH quality and to avoid loss for uplink communications.

In some aspects, the UE may be configured to disable CSI-RS-based UE beam selection based at least in part on a rotation speed of the UE failing to satisfy a second rotation speed threshold. For example, an IMU may measure the rotation speed of the UE and the UE may determine whether the rotation speed satisfies the first rotation speed threshold.

In some aspects, the UE may be configured to disable CSI-RS-based UE beam selection based at least in part on a movement speed failing to satisfy a second movement speed threshold. For example, the UE may measure the movement speed based at least in part on a Doppler measurement.

In some aspects, the UE may be configured to disable CSI-RS-based UE beam selection based at least in part on a DRX-on duration failing to satisfy a second cycle duration threshold. In some aspects, the UE may be configured to enable CSI-RS-based UE beam selection based at least in part on a DRX-on timer failing to satisfy a second on-duration timer threshold (e.g., indicating that the DRX-on cycle is extended for traffic).

In some aspects, a threshold for disabling the CSI-RS-based UE beam selection may be less than a threshold for enabling the CSI-RS-based UE beam selection. In this way, frequent alternating between enabling and disabling the CSI-RS-based UE beam selection may be reduced or avoided.

Based at least in part on the UE being configured to enable or disable CSI-RS-based UE beam selection based at least in part on one or more parameters of a communication link, the UE may increase benefits and reduce degradation associated with CSI-RS-based UE beam selection. For example, the UE may conserve communication, power, network, and/or communication resources that may have otherwise been consumed by detecting and correcting errors caused by always enabling CSI-RS-based UE beam selection. Additionally, or alternatively, the UE may conserve communication, power, network, and/or communication resources that may have otherwise been consumed by communicating using inefficient beam selection.

In some aspects, the UE may use CSI-RS-based UE beam selection while configured to communicate using multiple component carriers (e.g., using carrier aggregation). In some aspects, the UE may sweep the candidate UE beams on a CSI-RS resource (e.g., a CSI-RS acquisition resource) within multiple component carriers. For example, the UE may apply a first beam to the CSI-RS resources on the multiple component carriers (e.g., using time-division multiplexing and/or frequency-division multiplexing, among other examples).

The UE may combine metrics associated with the multiple component carriers and select a strongest beam based at least in part on the strongest beam being a beam associated with a highest spectral efficiency across the multiple component carriers (e.g., all active component carriers). In some aspects, the UE may combine the metrics based at least in part on using a weighted sum of spectral efficiencies across the multiple component carriers. For example, a primary component carrier may have a first weight and one or more secondary component carriers may have a second weight that is different from (e.g., lower than) the first weight.

Based at least in part on the UE using combined metrics associated with the multiple component carriers to select a strongest beam, the UE may communication with an improved spectral efficiency when communicating using the multiple component carriers. In this way, the UE may conserve communication, power, network, and/or communication resources that may have otherwise been consumed by communicating using a beam that selected based on metrics associated with only the primary component carrier, which may have lower spectral efficiency than the strongest beam as measured across the multiple component carriers. Additionally, or alternatively, based at least in part on a network node beam for CSI-RS acquisition being quasi-co-located (QCLed) with an active transmission configuration indicator (TCI) on a per component carrier basis, there is no need to require QCL between a secondary component carrier SSB and a primary component carrier SSB.

FIG. 7 is a diagram of an example 700 associated with CSI-RS-based UE beam selection, in accordance with the present disclosure. As shown in FIG. 7, a network node (e.g., base station 110, a CU, a DU, and/or an RU) may communicate with a UE (e.g., UE 120). In some aspects, the network node and the UE may be part of a wireless network (e.g., wireless network 100).

As shown by reference number 705, the network node and the UE may establish a communication link and the UE may receive configuration information. In some aspects, the UE may receive the configuration information via one or more of RRC signaling, one or more MAC-CEs, and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to enable CSI-RS-based UE beam selection based at least in part on one or more parameters of the communication link. In some aspects, the communication information may indicate that the UE is to transmit CSF associated with a previous CSI-RS resource based at least in part on using a CSI-RS resources for CSI-RS-based UE beam selection. In some aspects, the configuration information may indicate one or more thresholds for enabling or disabling CSI-RS-based UE beam selection at the UE.

The UE may configure itself based at least in part on the configuration information. In some aspects, the UE may be configured to perform one or more operations described herein based at least in part on the configuration information.

As shown by reference number 710, the UE may receive, and the network node may transmit, one or more SSBs. In some aspects, the UE may identify a set of one or more candidate UE beams based at least in part on the SSBs, with the one or more candidate UE beams to be used for CSI-RS-based UE beam selection. The UE may identify the one or more candidate UE beams based at least in part on one or more metrics (e.g., RSRP, SINR, SNR, or spectral efficiency, among other examples) associated with measuring the one or more SSBs via the one or more candidate UE beams (e.g., in addition to excluded available UE beams).

As shown by reference number 715, the UE may identify one or more parameters associated with the communication link. In some aspects, the one or more parameters may be associated with an improvement or degradation of communication efficiency when using CSI-RS-based UE beam selection.

The one or more parameters may include a signal strength of an SSB on a serving UE beam, a VPHR on a serving UE beam, a rotation speed of the UE, a UE movement speed, and/or a DRX cycle, among other examples.

As shown by reference number 720, the UE may enable CSI-RS-based UE beam selection based at least in part on the identified one or more parameters. For example, the UE may enable CSI-RS-based UE beam selection based at least in part on the signal strength of an SSB on a serving UE beam satisfying an SSB threshold, the VPHR on a serving UE beam satisfying a VPHR threshold, the rotation speed of the UE satisfying a rotation speed threshold, the UE movement speed satisfying a movement speed threshold, and/or the DRX cycle having a cycle duration that satisfies a cycle duration threshold.

As shown by reference number 725, the UE may receive, and the base station may transmit, a set of CSI-RSs. In some aspects, the set of CSI-RSs are associated with acquisition (e.g., for beam selection). In some aspects, the CSI may be configured for obtaining CSF.

As shown by reference number 730, the UE may measure the set of CSI-RSs via the set of candidate UE beams and/or within multiple component carriers. In some aspects, the UE may sweep the set of candidate UE beams to measure the CSI-RSs and obtain one or more metrics associated with candidate UE beams of the set of candidate UE beams. For example, the UE may measure RSRP of the set of CSI-RSs as measured using each of the set of candidate UE beams. The UE may sweep the set of candidate UE beams using time division multiplexing (e.g., sequentially using different candidate UE beams to measure the CSI-RSs) during one or more CSI-RS resources associated with the CSI-RSs.

In some aspects, the UE may measure the set of CSI-RSs via the set of candidate UE beams within multiple component carriers. For example, the UE may measure the set of CSI-RSs via one or more of the candidate UE beams on a primary component carrier and one or more secondary component carriers. In some aspects, the UE may measure the set of CSI-RSs of a same resource within the multiple component carriers using frequency division multiplexing and/or time division multiplexing. The UE may identify total spectral efficiencies, across the multiple component carriers, associated with one or more of the multiple UE beams.

As shown by reference number 735, the UE may select a UE beam based at least in part on the CSI-RSs. In some aspects, the UE may select the UE beam based at least in part on measurements of the set of CSI-RSs using the set of candidate UE beams.

In some aspects, the UE may identify the selected UE beam based at least in part on metrics associated with multiple component carriers, as measured via the multiple UE beams. For example, the UE may identify the selected UE beam based at least in part on the selected UE beam having a highest measured or estimated spectral efficiency across multiple component carriers (e.g., a total spectral efficiency associated with using the selected UE beam on multiple component carriers including at least one secondary component carrier). In some aspects, the selected UE beam is associated with a first spectral efficiency for a primary component carrier and an additional UE beam is associated with a second spectral efficiency for the primary component carrier, wherein the second spectral efficiency is greater than the first spectral efficiency. In this way, the selected beam may have a higher total spectral efficiency over the multiple component carriers even though the additional UE beam that is not selected has a higher spectral efficiency on the primary component carrier.

In some aspects, the total spectral efficiencies include weighted sums of spectral efficiencies across the multiple component carriers. For example, a first weight may be applied to a primary component carrier, and a second weight may be applied to one or more secondary component carriers, with the second weight is different from the first weight.

As shown by reference number 740, the UE may receive an additional set of CSI-RSs. In some aspects, the additional set of CSI-RSs may be a set of CSI-RSs received via a next CSI-RS resource (e.g., after CSI-RS-based UE beam selection)

As shown by reference number 745, the UE may transmit, and the base station may receive, an indication of CSF. For example, the UE may transmit the indication of CSF based at least in part on the additional set of CSI-RSs (e.g., using the selected UE beam) based at least in part on not using the additional set of CSI-RSs for CSI-RS-based UE beam selection.

As shown by reference number 750, the UE may identify a change to the one or more parameters. For example, the UE may obtain one or more metrics associated with the one or more parameters using one or more communications from the network node. For example, the UE may obtain an indication of a change to a configuration for downlink communications (e.g., a rank, a DRX cycle, a DRX-on timer, an MCS, a number of component carriers, among other examples) and/or may measure one or more metrics associated with signal strength (e.g., RSRP, SINR, or SNR, among other examples) a VPHR, a UE rotation speed, and/or a UE movement speed, among other examples.

As shown by reference number 755, the UE may disable the CSI-RS-based UE beam selection based at least in part on the identified parameters. For example, the UE may disable CSI-RS-based UE beam selection based at least in part on the one or more parameters failing to satisfy one or more thresholds (e.g., which may be different from thresholds associated with enabling CSI-RS-based UE beam selection). The UE may disable the CSI-RS-based UE beam selection based at least in part on a signal strength of an SSB on a serving UE beam failing to satisfy an SSB threshold, a VPHR on a serving UE beam failing to satisfy a VPHR threshold, a rotation speed of the UE failing to satisfy a rotation speed threshold, a UE movement speed failing to satisfy a movement speed threshold, and/or a DRX cycle having a cycle duration that fails to satisfy a cycle duration threshold, among other examples.

Based at least in part on the UE being configured to enable or disable CSI-RS-based UE beam selection based at least in part on one or more parameters of a communication link, the UE may increase benefits and reduce degradation associated with CSI-RS-based UE beam selection. For example, the UE may conserve communication, power, network, and/or communication resources that may have otherwise been consumed by detecting and correcting errors caused by always enabling CSI-RS-based UE beam selection. Additionally, or alternatively, the UE may conserve communication, power, network, and/or communication resources that may have otherwise been consumed by communicating using inefficient beam selection.

Based at least in part on the UE measuring the CSI-RSs within multiple component carriers and selecting the UE beam based at least in part on measurements of the CSI-RSs over the multiple component carriers (e.g., a total spectral efficiency over the multiple component carriers), the UE may conserve communication, power, network, and/or communication resources that may have otherwise been consumed by communicating using a beam that selected based on metrics associated with only the primary component carrier, which may have lower spectral efficiency than the strongest beam as measured across the multiple component carriers. Additionally, or alternatively, based at least in part on a network node beam for CSI-RS acquisition being QCLed with an active TCI on a per component carrier basis, there is no need to require QCL between a secondary component carrier SSB and a primary component carrier SSB.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with techniques for CSI-RS-based UE beam selection.

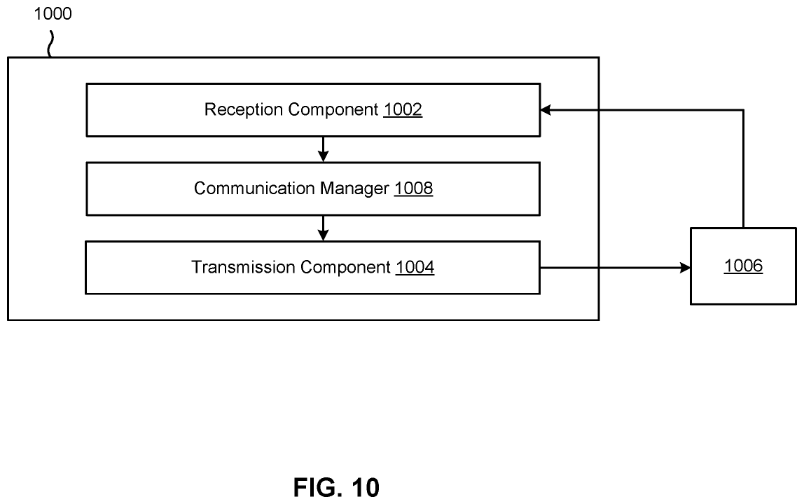

As shown in FIG. 8, in some aspects, process 800 may include identifying one or more parameters associated with a communication link (block 810). For example, the UE (e.g., using communication manager 140 and/or communication manager 1008, depicted in FIG. 10) may identify one or more parameters associated with a communication link, as described above.

As further shown in FIG. 8, in some aspects, process 800 may include enabling, based at least in part on the identified one or more parameters, CSI-RS-based UE beam selection (block 820). For example, the UE (e.g., using communication manager 140 and/or communication manager 1008, depicted in FIG. 10) may enable, based at least in part on the identified one or more parameters, CSI-RS-based UE beam selection, as described above.

As further shown in FIG. 8, in some aspects, process 800 may include receiving a set of CSI-RSs (block 830). For example, the UE (e.g., using communication manager 140 and/or reception component 1002, depicted in FIG. 10) may receive a set of CSI-RSs, as described above.

As further shown in FIG. 8, in some aspects, process 800 may include selecting a UE beam based at least in part on the CSI-RSs (block 840). For example, the UE (e.g., using communication manager 140 and/or communication manager 1008, depicted in FIG. 10) may select a UE beam based at least in part on the CSI-RSs, as described above.

Process 800 may include additional aspects, such as any single aspect or any combination of aspects described below and/or in connection with one or more other processes described elsewhere herein.

In a first aspect, process 800 includes measuring the set of CSI-RSs via a set of candidate UE beams, and identifying the selected UE beam based at least in part on the measurements.

In a second aspect, alone or in combination with the first aspect, measurement of the set of CSI-RSs via the set of candidate UE beams comprises measuring the set of CSI-RSs within multiple component carriers.

In a third aspect, alone or in combination with one or more of the first and second aspects, measurement of the set of CSI-RSs within the multiple component carriers comprises measuring the set of CSI-RSs of a same resource using one or more of frequency division multiplexing or time division multiplexing.

In a fourth aspect, alone or in combination with one or more of the first through third aspects, identification of the selected UE beam based at least in part the CSI-RSs comprises identifying the selected UE beam based at least in part on a total spectral efficiency associated with using the selected UE beam on multiple component carriers.

In a fifth aspect, alone or in combination with one or more of the first through fourth aspects, process 800 includes receiving an additional set of CSI-RSs, and transmitting an indication of channel state feedback based at least in part on the additional set of CSI-RSs.

In a sixth aspect, alone or in combination with one or more of the first through fifth aspects, the one or more parameters comprise one or more of a signal strength of a SSB on a serving UE beam, a VPHR on a serving UE beam, a rotation speed of the UE, a UE movement speed, or a DRX cycle.

In a seventh aspect, alone or in combination with one or more of the first through sixth aspects, the enablement of the CSI-RS-based UE beam selection is based at least in part on one or more of the signal strength of an SSB on a serving UE beam satisfying an SSB threshold, the VPHR on a serving UE beam satisfying a VPHR threshold, the rotation speed of the UE satisfying a rotation speed threshold, the UE movement speed satisfying a movement speed threshold, or the DRX cycle having a cycle duration that satisfies a cycle duration threshold.

In an eighth aspect, alone or in combination with one or more of the first through seventh aspects, process 800 includes disabling, based at least in part on the identified one or more parameters, the CSI-RS-based UE beam selection.

In a ninth aspect, alone or in combination with one or more of the first through eighth aspects, the disablement of the CSI-RS-based UE beam selection is based at least in part on one or more of a signal strength of an SSB on a serving UE beam failing to satisfy an SSB threshold, a VPHR on a serving UE beam failing to satisfy a VPHR threshold, a rotation speed of the UE failing to satisfy a rotation speed threshold, a UE movement speed failing to satisfy a movement speed threshold, or a DRX cycle having a cycle duration that fails to satisfy a cycle duration threshold.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with techniques for channel state information reference signal-based user equipment beam selection.

As shown in FIG. 9, in some aspects, process 900 may include measuring, via multiple UE beams, a set of CSI-RSs within multiple component carriers (block 910). For example, the UE (e.g., using communication manager 140 and/or communication manager 1008, depicted in FIG. 10) may measure, via multiple UE beams, a set of CSI-RSs within multiple component carriers, as described above.

As further shown in FIG. 9, in some aspects, process 900 may include identifying total spectral efficiencies, across the multiple component carriers, associated with one or more of the multiple UE beams (block 920). For example, the UE (e.g., using communication manager 140 and/or communication manager 1008, depicted in FIG. 10) may identify total spectral efficiencies, across the multiple component carriers, associated with one or more of the multiple UE beams, as described above.

As further shown in FIG. 9, in some aspects, process 900 may include selecting a UE beam, of the one or more of the multiple UE beams, based at least in part on the total spectral efficiencies across the multiple component carriers (block 930). For example, the UE (e.g., using communication manager 140 and/or communication manager 1008, depicted in FIG. 10) may select a UE beam, of the one or more of the multiple UE beams, based at least in part on the total spectral efficiencies across the multiple component carriers, as described above.

Process 900 may include additional aspects, such as any single aspect or any combination of aspects described below and/or in connection with one or more other processes described elsewhere herein.

In a first aspect, the total spectral efficiencies comprise weighted sums of spectral efficiencies.

In a second aspect, alone or in combination with the first aspect, the weighted sums of spectral efficiencies comprise a first weight applied to a primary component carrier, and a second weight applied to one or more secondary component carriers, wherein the second weight is different from the first weight.

In a third aspect, alone or in combination with one or more of the first and second aspects, the selected UE beam is associated with a first spectral efficiency for a primary component carrier, and wherein an additional UE beam, of the one or more of the multiple UE beams, is associated with a second spectral efficiency for the primary component carrier, wherein the second spectral efficiency is greater than the first spectral efficiency.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008 (e.g., the communication manager 140).

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8, process 900 of FIG. 9, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1008 may identify one or more parameters associated with a communication link. The communication manager 1008 may enable, based at least in part on the identified one or more parameters, CSI-RS-based UE beam selection. The reception component 1002 may receive a set of CSI-RSs. The communication manager 1008 may select a UE beam based at least in part on the CSI-RSs.

The communication manager 1008 and/or the reception component 1002 may measure the set of CSI-RSs via a set of candidate UE beams.

The communication manager 1008 may identify the selected UE beam based at least in part on the measurements.

The reception component 1002 may receive an additional set of CSI-RSs.

The transmission component 1004 may transmit an indication of channel state feedback based at least in part on the additional set of CSI-RSs.

The communication manager 1008 may disable, based at least in part on the identified one or more parameters, the CSI-RS-based UE beam selection.

The communication manager 1008 and/or the reception component 1002 may measure, via multiple UE beams, a set of CSI-RSs within multiple component carriers. The communication manager 1008 may identify total spectral efficiencies, across the multiple component carriers, associated with one or more of the multiple UE beams. The communication manager 1008 may select a UE beam, of the one or more of the multiple UE beams, based at least in part on the total spectral efficiencies across the multiple component carriers.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: identifying one or more parameters associated with a communication link; enabling, based at least in part on the identified one or more parameters, channel state information reference signal (CSI-RS)-based UE beam selection; receiving a set of CSI-RSs; and selecting a UE beam based at least in part on the CSI-RSs.

Aspect 2: The method of Aspect 1, further comprising: measuring the set of CSI-RSs via a set of candidate UE beams; and identifying the selected UE beam based at least in part on the measurements.

Aspect 3: The method of Aspect 2, wherein measurement of the set of CSI-RSs via the set of candidate UE beams comprises: measuring the set of CSI-RSs within multiple component carriers.

Aspect 4: The method of Aspect 3, wherein measurement of the set of CSI-RSs within the multiple component carriers comprises: measuring the set of CSI-RSs of a same resource using one or more of frequency division multiplexing or time division multiplexing.

Aspect 5: The method of any of Aspects 2-4, wherein identification of the selected UE beam based at least in part the CSI-RSs comprises: identifying the selected UE beam based at least in part on a total spectral efficiency associated with using the selected UE beam on multiple component carriers.

Aspect 6: The method of any of Aspects 1-5, further comprising: receiving an additional set of CSI-RSs; and transmitting an indication of channel state feedback based at least in part on the additional set of CSI-RSs.

Aspect 7: The method of any of Aspects 1-6, wherein the one or more parameters comprise one or more of: a signal strength of a synchronization signal block (SSB) on a serving UE beam, a virtual power headroom (VPHR) on a serving UE beam, a rotation speed of the UE, a UE movement speed, or a discontinuous reception (DRX) cycle.

Aspect 8: The method of Aspect 7, wherein the enablement of the CSI-RS-based UE beam selection is based at least in part on one or more of: the signal strength of an SSB on a serving UE beam satisfying an SSB threshold, the VPHR on a serving UE beam satisfying a VPHR threshold, the rotation speed of the UE satisfying a rotation speed threshold, the UE movement speed satisfying a movement speed threshold, or the DRX cycle having a cycle duration that satisfies a cycle duration threshold.

Aspect 9: The method of any of Aspects 1-8, further comprising: disabling, based at least in part on the identified one or more parameters, the CSI-RS-based UE beam selection.

Aspect 10: The method of Aspect 9, wherein the disablement of the CSI-RS-based UE beam selection is based at least in part on one or more of: a signal strength of an SSB on a serving UE beam failing to satisfy an SSB threshold, a virtual power headroom (VPHR) on a serving UE beam failing to satisfy a VPHR threshold, a rotation speed of the UE failing to satisfy a rotation speed threshold, a UE movement speed failing to satisfy a movement speed threshold, or a discontinuous reception (DRX) cycle having a cycle duration that fails to satisfy a cycle duration threshold.

Aspect 11: A method of wireless communication performed by a user equipment (UE), comprising: measuring, via multiple UE beams, a set of channel state information reference signals (CSI-RSs) within multiple component carriers; identifying total spectral efficiencies, across the multiple component carriers, associated with one or more of the multiple UE beams; and selecting a UE beam, of the one or more of the multiple UE beams, based at least in part on the total spectral efficiencies across the multiple component carriers.

Aspect 12: The method of Aspect 11, wherein the total spectral efficiencies comprise weighted sums of spectral efficiencies.

Aspect 13: The method of Aspect 12, wherein the weighted sums of spectral efficiencies comprise: a first weight applied to a primary component carrier, and a second weight applied to one or more secondary component carriers, wherein the second weight is different from the first weight.

Aspect 14: The method of any of Aspects 11-13, wherein the selected UE beam is associated with a first spectral efficiency for a primary component carrier, and wherein an additional UE beam, of the one or more of the multiple UE beams, is associated with a second spectral efficiency for the primary component carrier, wherein the second spectral efficiency is greater than the first spectral efficiency.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
identifying one or more parameters associated with a communication link;
enabling, based at least in part on the identified one or more parameters, channel state information reference signal (CSI-RS)-based UE beam selection;
receiving a set of CSI-RSs; and
selecting a UE beam based at least in part on the CSI-RSs.

2. The method of claim 1, further comprising:
measuring the set of CSI-RSs via a set of candidate UE beams; and
identifying the selected UE beam based at least in part on the measurements.

3. The method of claim 2, wherein measurement of the set of CSI-RSs via the set of candidate UE beams comprises:
measuring the set of CSI-RSs within multiple component carriers.

4. The method of claim 3, wherein measurement of the set of CSI-RSs within the multiple component carriers comprises:
measuring the set of CSI-RSs of a same resource using one or more of frequency division multiplexing or time division multiplexing.

5. The method of claim 2, wherein identification of the selected UE beam based at least in part the CSI-RSs comprises:
identifying the selected UE beam based at least in part on a total spectral efficiency associated with using the selected UE beam on multiple component carriers.

6. The method of claim 1, further comprising:
receiving an additional set of CSI-RSs; and
transmitting an indication of channel state feedback based at least in part on the additional set of CSI-RSs.

7. The method of claim 1, wherein the one or more parameters comprise one or more of:
a signal strength of a synchronization signal block (SSB) on a serving UE beam,
a virtual power headroom (VPHR) on a serving UE beam,
a rotation speed of the UE,
a UE movement speed, or
a discontinuous reception (DRX) cycle.

8. The method of claim 7, wherein the enablement of the CSI-RS-based UE beam selection is based at least in part on one or more of:
the signal strength of an SSB on a serving UE beam satisfying an SSB threshold,
the VPHR on a serving UE beam satisfying a VPHR threshold,
the rotation speed of the UE satisfying a rotation speed threshold,
the UE movement speed satisfying a movement speed threshold, or
the DRX cycle having a cycle duration that satisfies a cycle duration threshold.

9. The method of claim 1, further comprising:
disabling, based at least in part on the identified one or more parameters, the CSI-RS-based UE beam selection.

10. The method of claim 9, wherein the disablement of the CSI-RS-based UE beam selection is based at least in part on one or more of:
a signal strength of an SSB on a serving UE beam failing to satisfy an SSB threshold,
a virtual power headroom (VPHR) on a serving UE beam failing to satisfy a VPHR threshold,
a rotation speed of the UE failing to satisfy a rotation speed threshold,
a UE movement speed failing to satisfy a movement speed threshold, or
a discontinuous reception (DRX) cycle having a cycle duration that fails to satisfy a cycle duration threshold.

11. A user equipment (UE) for wireless communication, comprising:
a memory; and
one or more processors, coupled to the memory, configured to:
identify one or more parameters associated with a communication link;
enable, based at least in part on the identified one or more parameters, channel state information reference signal (CSI-RS)-based UE beam selection;
receive a set of CSI-RSs; and
select a UE beam based at least in part on the CSI-RSs.

12. The UE of claim 11, wherein the one or more processors are further configured to:
measure the set of CSI-RSs via a set of candidate UE beams; and
identify the selected UE beam based at least in part on the measurements.

13. The UE of claim 12, wherein the one or more processors, to measure the set of CSI-RSs via the set of candidate UE beams, are further configured to:
Measure the set of CSI-RSs within multiple component carriers.

14. The UE of claim 13, wherein the one or more processors, to measure the set of CSI-RSs within the multiple component carriers, are further configured to:
measure the set of CSI-RSs of a same resource using one or more of frequency division multiplexing or time division multiplexing.

15. The UE of claim 12, wherein the one or more processors, to identify the selected UE beam, are further configured to:
identify the selected UE beam based at least in part on a total spectral efficiency associated with using the selected UE beam on multiple component carriers.

16. The UE of claim 11, wherein the one or more processors are further configured to:
receive an additional set of CSI-RSs; and
transmit an indication of channel state feedback based at least in part on the additional set of CSI-RSs.

17. The UE of claim 11, wherein the one or more parameters comprise one or more of:
a signal strength of a synchronization signal block (SSB) on a serving UE beam,
a virtual power headroom (VPHR) on a serving UE beam,
a rotation speed of the UE,
a UE movement speed, or
a discontinuous reception (DRX) cycle.

18. The UE of claim 17, wherein the enablement of the CSI-RS-based UE beam selection is based at least in part on one or more of:
the signal strength of an SSB on a serving UE beam satisfying an SSB threshold,
the VPHR on a serving UE beam satisfying a VPHR threshold,
the rotation speed of the UE satisfying a rotation speed threshold,
the UE movement speed satisfying a movement speed threshold, or
the DRX cycle having a cycle duration that satisfies a cycle duration threshold.

19. The UE of claim 11, wherein the one or more processors are further configured to:
disable, based at least in part on the identified one or more parameters, the CSI-RS-based UE beam selection.

20. The UE of claim 19, wherein the disablement of the CSI-RS-based UE beam selection is based at least in part on one or more of:
a signal strength of an SSB on a serving UE beam failing to satisfy an SSB threshold,
a virtual power headroom (VPHR) on a serving UE beam failing to satisfy a VPHR threshold,
a rotation speed of the UE failing to satisfy a rotation speed threshold,
a UE movement speed failing to satisfy a movement speed threshold, or
a discontinuous reception (DRX) cycle having a cycle duration that fails to satisfy a cycle duration threshold.

21. A non-transitory computer-readable medium storing a set of instructions for wireless communication, the set of instructions comprising:
one or more instructions that, when executed by one or more processors of a user equipment (UE), cause the UE to:
identify one or more parameters associated with a communication link;
enable, based at least in part on the identified one or more parameters, channel state information reference signal (CSI-RS)-based UE beam selection;
receive a set of CSI-RSs; and
select a UE beam based at least in part on the CSI-RSs.

22. The non-transitory computer-readable medium of claim 21, wherein the one or more instructions further cause the UE to:
measure the set of CSI-RSs via a set of candidate UE beams; and
identify the selected UE beam based at least in part on the measurements.

23. The non-transitory computer-readable medium of claim 22, wherein the one or more instructions further cause the UE to:
measure the set of CSI-RSs within multiple component carriers.

24. The non-transitory computer-readable medium of claim 23, wherein the one or more instructions further cause the UE to:
measure the set of CSI-RSs of a same resource using one or more of frequency division multiplexing or time division multiplexing.

25. The non-transitory computer-readable medium of claim 22, wherein the one or more instructions further cause the UE to:
identify the selected UE beam based at least in part on a total spectral efficiency associated with using the selected UE beam on multiple component carriers.

26. An apparatus for wireless communication, comprising:
means for identifying one or more parameters associated with a communication link;
means for enabling, based at least in part on the identified one or more parameters, channel state information reference signal (CSI-RS)-based UE beam selection;
means for receiving a set of CSI-RSs; and
means for selecting a UE beam based at least in part on the CSI-RSs.

27. The apparatus of claim 26, further comprising:
means for measuring the set of CSI-RSs via a set of candidate UE beams; and
means for identifying the selected UE beam based at least in part on the measurements.

28. The apparatus of claim 27, further comprising:
means for measuring the set of CSI-RSs within multiple component carriers.

29. The apparatus of claim 28, further comprising:
means for measuring the set of CSI-RSs of a same resource using one or more of frequency division multiplexing or time division multiplexing.

30. The apparatus of claim 27, further comprising:
means for identifying the selected UE beam based at least in part on a total spectral efficiency associated with using the selected UE beam on multiple component carriers.
